(19) United States
(12) Patent Application Publication
(10) Pub. No.: US 2024/0377551 A1
(43) Pub. Date: Nov. 14, 2024

(54) MODELING ACOUSTIC IMPEDANCE OF A SUBTERRANEAN FORMATION

(71) Applicant: Saudi Arabian Oil Company, Dhahran (SA)

(72) Inventor: Jimmy Ardila, Dhahran (SA)

(21) Appl. No.: 18/315,880

(22) Filed: May 11, 2023

(51) Int. Cl. G01V 1/50

(52) U.S. Cl. CPC G01V 1/50; G01V 2210/6169; G01V 2210/6226

(57) ABSTRACT

Systems and methods for geophysical exploration of a subterranean formation include acquiring seismic data representing the subterranean formation; generating an initial acoustic impedance volume based on the seismic data; measuring properties of the subterranean formation at one or more wells extending into the subterranean formation using a logging tool; and storing values of the measured properties in a well log for each well. For each well, an acoustic impedance is calculated at different depths based on the well log, and a residual is calculated between the acoustic impedance based on the well log and the initial acoustic impedance volume at the location of the well. A residual volume is generated based on the calculated residuals from the one or more wells. A corrected acoustic impedance volume representing the subterranean formation based on the residual volume and the initial acoustic impedance volume is generated.

### TECHNICAL FIELD

The present disclosure generally relates to geophysical exploration of a subterranean formation.

### BACKGROUND

In geology, sedimentary facies are bodies of sediment that are recognizably distinct from adjacent sediments that resulted from different depositional environments. Generally, geologists distinguish facies by aspects of the rock or sediment being studied. Seismic facies are groups of seismic reflections whose parameters (such as amplitude, continuity, reflection geometry, and frequency) differ from those of adjacent groups. Seismic facies analysis, a subdivision of seismic stratigraphy, plays an important role in hydrocarbon exploration and is one key step in the interpretation of seismic data for reservoir characterization. The seismic facies in a given geological area can provide useful information, particularly about the types of sedimentary deposits and the anticipated lithology.

In reflection seismology, geologists and geophysicists perform seismic surveys to map and interpret sedimentary facies and other geologic features for applications such as, for example, identification pf potential petroleum reservoirs. Seismic surveys are conducted by using a controlled seismic source (for example, Vibroseis or dynamite) to create a seismic wave. The seismic source is typically located at ground surface. The seismic wave travels into the ground, is reflected by subsurface formations, and returns to the surface where it is recorded by sensors called geophones. The geologists and geophysicists analyze the time it takes for the seismic waves to reflect off subsurface formations and return to the surface to map sedimentary facies and other geologic features. This analysis can also incorporate data from sources such as, for example, borehole logging, gravity surveys, and magnetic surveys.

### SUMMARY

This disclosure describes systems and methods for geophysical exploration of a subterranean formation. Three-dimensional (3D) geocellular modeling can be used to represent the heterogeneity across many scales using diverse types of data. The systems and methods of this disclosure utilize 3D acoustic impedance volumes representing the subterranean formation derived from seismic reflections and high-frequency well-log based acoustic impedance data to generate corrected acoustic impedance volumes.

In one aspect, a method for geophysical exploration of a subterranean formation includes acquiring seismic data representing the subterranean formation; generating an initial acoustic impedance volume based on the seismic data; measuring properties of the subterranean formation at one or more wells extending into the subterranean formation using a logging tool; storing values of the measured properties in a well log for each well; for each well, calculating an acoustic impedance at different depths based on the well log; for each well, calculating a residual between the acoustic impedance based on the well log and the initial acoustic impedance volume at the location of the well; generating a residual volume based on the calculated residuals from the one or more wells; and generating a corrected acoustic impedance volume representing the subterranean formation based on the residual volume and the initial acoustic impedance volume.

In one aspect, a system for geophysical exploration of a subterranean formation includes at least one processor; and a memory storing instructions that, when executed by the at least one processor, cause the at least one processor to perform operations including acquiring seismic data representing the subterranean formation; generating an initial acoustic impedance volume based on the seismic data; measuring properties of the subterranean formation at one or more wells extending into the subterranean formation using a logging tool; storing values of the measured properties in a well log for each well; for each well, calculating an acoustic impedance at different depths based on the well log; for each well, calculating a residual between the acoustic impedance based on the well log and the initial acoustic impedance volume at the location of the well; generating a residual volume based on the calculated residuals from the one or more wells; and generating a corrected acoustic impedance volume representing the subterranean formation based on the residual volume and the initial acoustic impedance volume.

In one aspect, one or more non-transitory machine-readable storage devices storing instructions for geophysical modeling of a subterranean formation, the instructions being executable by one or more processing devices to cause performance of operations including acquiring seismic data representing the subterranean formation; generating an initial acoustic impedance volume based on the seismic data; measuring properties of the subterranean formation at one or more wells extending into the subterranean formation using a logging tool; storing values of the measured properties in a well log for each well; for each well, calculating an acoustic impedance at different depths based on the well log; for each well, calculating a residual between the acoustic impedance based on the well log and the initial acoustic impedance volume at the location of the well; generating a residual volume based on the calculated residuals from the one or more wells; and generating a corrected acoustic impedance volume representing the subterranean formation based on the residual volume and the initial acoustic impedance volume.

Embodiments of these aspects can include one or more of the following features.

In some embodiments, generating a corrected acoustic impedance volume includes adding the residual volume to the initial acoustic impedance volume.

In some embodiments, the well log includes at least one of a sonic log and a density log.

In some embodiments, generating a residual volume includes applying a spatial interpolation between calculated residuals of the one or more wells in the subterranean formation. In some cases, the spatial interpolation includes a kriging method.

In some cases, these aspects further include for each well, segmenting the calculated residual based on slopes of the initial acoustic impedance volume at the location of the well; for each segment of the calculated residual, determining a slope and an intercept by applying a linear regression fit to the calculated residual; and where the kriging method determines the spatial interpolation between calculated residuals of the one or more wells based at least in part on the determined slopes and intercepts of the segments.

In some embodiments, these aspects further include iteratively performing steps including for each well, calculating a residual between the acoustic impedance based on the well log and the corrected acoustic impedance volume at the location of the well; generating a new residual volume based on the calculated residuals from the one or more wells; and generating a new corrected acoustic impedance volume representing the subterranean formation based on the residual volume and the corrected acoustic impedance volume, where the corrected acoustic impedance volume comprises the new corrected acoustic impedance volume from the previous iteration.

In some embodiments, these aspects further include determining a location to produce hydrocarbons from the subterranean formation based at least in part on the corrected acoustic impedance volume. In some cases, these aspects further include producing hydrocarbons from the subterranean formation.

Certain implementations of these aspects can provide particular advantages. The systems and methods of this disclosure can generate corrected acoustic impedance volumes with less computation time than conventional methods. The corrected acoustic impedance volumes can reduce the uncertainty of stratigraphic interpretation of 3D reservoir models. Using high-frequency well log data to correct the seismically derived acoustic impedance can reduce biases in the seismically derived acoustic impedance providing a more accurate representation of the subterranean formation. High frequency corrections to the acoustic impedance can be based on geological knowledge of the subterranean formation. Implementations of these aspects incorporate the heterogeneity observed in well-log derived acoustic impedance into the seismically derived acoustic impedance volume.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic view of a seismic survey being performed to map subterranean features such as facies and faults.

FIG. 2 is a flow chart of a method for geophysical exploration of a subterranean formation.

FIG. 3 shows a plot comparing seismically derived acoustic impedance of a subterranean formation with a well log derived acoustic impedance.

FIG. 4 is a plot of a generated acoustic impedance residual.

FIG. 5A shows frequency spectra of acoustic power attenuation based on seismically derived acoustic impedance, well log derived acoustic impedance, and a corrected volume of acoustic impedance.

FIGS. 5B-5C show plots of acoustic impedance against derived porosity.

FIG. 6 is a block diagram illustrating an example computer system used to provide computational functionalities associated with described algorithms, methods, functions, processes, flows, and procedures according to some implementations of the present disclosure.

### DETAILED DESCRIPTION

This specification describes systems and methods for geophysical exploration of a subterranean formation. Three-dimensional (3D) geocellular modeling can be used to represent the heterogeneity across many scales using diverse types of data. The systems and methods of this disclosure utilize 3D acoustic impedance volumes representing the subterranean formation derived from seismic reflections and high frequency well-log based acoustic impedance data to generate corrected acoustic impedance volumes.

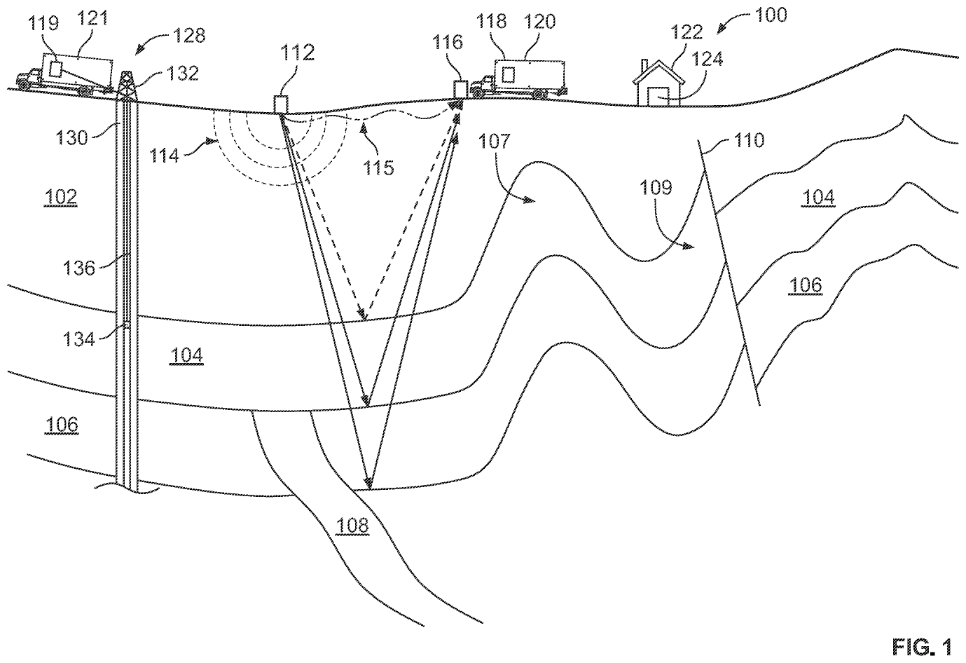

FIG. 1 is a schematic view of a seismic survey being performed to map subterranean features such as facies and faults in a subterranean formation 100. The seismic survey can be used to generate an acoustic impedance volume that relates the density of the subterranean formation to the compressional sound velocity in the subterranean formation. The subterranean formation 100 includes a layer of impermeable cap rocks 102 at the surface. Facies underlying the impermeable cap rocks 102 include a sandstone layer 104, a limestone layer 106, and a sand layer 108. A fault line 110 extends across the sandstone layer 104 and the limestone layer 106.

A seismic source 112 (for example, a seismic vibrator or an explosion) generates seismic waves 114 that propagate in the earth. The velocity of these seismic waves depends on properties such as, for example, density, porosity, and fluid content of the medium through which the seismic waves are traveling. Different geologic bodies or layers in the earth are distinguishable because the layers have different properties and, thus, different characteristic seismic velocities. For example, in the subterranean formation 100, the velocity of seismic waves traveling through the subterranean formation 100 will be different in the sandstone layer 104, the limestone layer 106, and the sand layer 108. As the seismic waves 114 contact interfaces between geologic bodies or layers that have different velocities, the interface reflects some of the energy of the seismic wave and refracts part of the energy of the seismic wave. Such interfaces are sometimes referred to as horizons.

The seismic waves 114 are received by a sensor or sensors 116. Although illustrated as a single component in FIG. 1, the sensor or sensors 116 are typically a line or an array of sensors 116 that generate an output signal in response to received seismic waves including waves reflected by the horizons in the subterranean formation 100. The sensors 116 can be geophone-receivers that produce electrical output signals transmitted as input data, for example, to a computer 118 on a seismic control truck 120. Based on the input data, the computer 118 may generate a seismic data output such as, for example, a seismic two-way response time plot.

A control center 122 can be operatively coupled to the seismic control truck 120 and other data acquisition and wellsite systems. The control center 122 may have computer facilities for receiving, storing, processing, and/or analyzing data from the seismic control truck 120 and other data acquisition and wellsite systems. For example, computer systems 124 in the control center 122 can be configured to analyze, model, control, optimize, or perform management tasks of field operations associated with development and production of resources such as oil and gas from the subterranean formation 100. Alternatively, the computer systems 124 can be located in a different location than the control center 122. Some computer systems are provided with functionality for manipulating and analyzing the data, such as performing seismic interpretation or borehole resistivity image log interpretation to identify geological surfaces in the subterranean formation or performing simulation, planning, and optimization of production operations of the wellsite systems.

In some embodiments, results generated by the computer system 124 may be displayed for user viewing using local or remote monitors or other display units. One approach to analyzing seismic data is to associate the data with portions of a seismic cube representing the subterranean formation 100. The seismic cube can also display results of the analysis of the seismic data associated with the seismic survey.

In some embodiments, a wellbore 130 that has been drilled in the subterranean formation 100 is logged in a well logging operation 128. The wellbore 130 extends downhole from a wellhead 132. The wellbore 130 is a vertical wellbore but well logging can also be performed in other wellbores, for example, slanted or horizontal wellbores. In the well logging operation 128, the wellbore 130 penetrates through three layers 102, 104, and 106 of a subterranean formation 100. A control truck 121 lowers a logging tool 134 down the wellbore 130 on a wireline 136.

The logging tool 134 is string of one or more instruments with sensors operable to measure geophysical properties of the subterranean formation 100. For example, logging tools can include resistivity logs, borehole image logs, porosity logs, density logs, or sonic logs. Resistivity logs measure the subsurface electrical resistivity, which is the ability to impede the flow of electric current. These logs can help differentiate between formations filled with salty waters (good conductors of electricity) and those filled with hydrocarbons (poor conductors of electricity). Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which typically a function of lithology and rock texture but particularly porosity. The logging tool consists of a piezoelectric transmitter and receiver and the time taken for the sound wave to travel the fixed distance between the two is recorded as an interval transit time.

As the logging tool 134 travels downhole, measurements of formations properties are recorded to generate a well log. In the illustrated operation, the data are recorded at the control truck 121 in real-time. Real-time data are recorded directly against measured cable depth. In some well-logging operations, the data is recorded at the logging tool 134 and downloaded later. In this approach, the downhole data and depth data are both recorded against time The two data sets are then merged using the common time base to create an instrument response versus depth log.

In the well logging operation 128, the well logging is performed on a wellbore 110 that has already been drilled. In some operations, well logging is performed in the form of logging while drilling techniques. In these techniques, the sensors are integrated into the drill string and the measurements are made in real-time, during drilling rather than using sensors lowered into a well after drilling.

Acoustic impedance is a physical property of a medium (e.g., rock, fluid, and combinations of rocks and fluids). Acoustic impedance can be a function of the density of the medium and the sound velocity (e.g., seismic velocity, compressional velocity) traveling through the medium. The acoustic impedance of a subterranean formation can be derived from seismic measurements, for example, the seismic measurements described in reference to FIG. 1. The acoustic impedance derived from seismic data can be biased toward low frequency content. Acoustic impedance of a subterranean formation can also be derived from well log data. Well log data can include higher frequencies than the seismic data. For example, in some implementations, seismic data can include frequencies up to about 25 Hz, and well log data can include frequencies up to about 75 Hz. The subterranean formation can attenuate higher frequency seismic waves more rapidly than lower frequencies. Acoustic impedance can be used to identify regions of the subterranean formation that are likely to hold hydrocarbons.

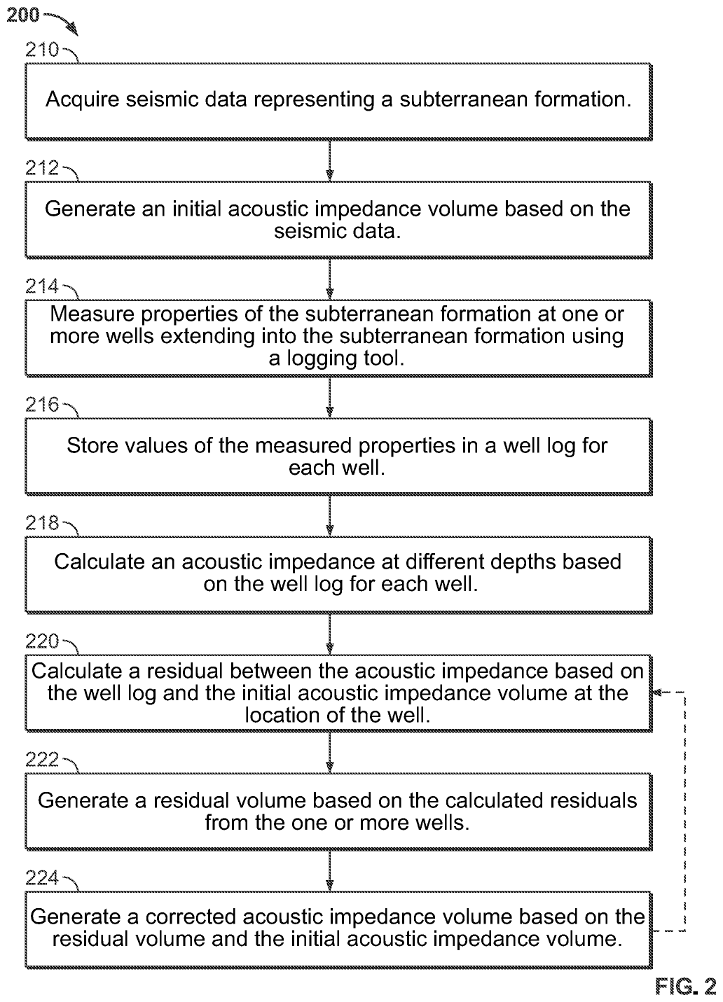

FIG. 2 is a flow chart of an example method 200 of geophysical exploration of a subterranean formation. The method 200 uses seismic data and well log data to generate a corrected acoustic impedance volume representing the subterranean formation. The corrected acoustic impedance generated by method 200 can be obtained with less computation time than conventional methods. Conventional methods can include deterministic and stochastic seismic inversion processes with wavelet extraction techniques that are complex and time consuming to obtain sufficient resolution to model the high frequency component. For example, a corrected acoustic impedance volume can be generated in weeks of computations by method 200 versus months of computations for conventional methods.

Seismic data is acquired from the target subterranean formation (210). For example, the seismic data can be collected by a seismic survey as described in reference to FIG. 1. The seismic data can be acquired from two dimensional (2D) seismic surveys, 3D seismic surveys, or a combination of 2D and 3D seismic surveys. Seismic data acquired at a variety of resolution scales can be collected. In some implementations, the seismic data can be accessed from a data store.

An initial acoustic impedance volume can be generated based on the seismic data (212). The initial acoustic impedance volume can be generated, for example, through a deterministic seismic inversion process that performs a multiplication of the rock density and the compressional velocity. The seismic reflectivity series can be based at least in part on density and seismic velocity logs present at a well. The seismic inversion process can resolve the low frequency content without the reaching the complexity or resolution of a seismic inversion process that can model the missing high frequency content. In some implementations, a stochastic seismic inversion process can be use to generate several acoustic impedance traces that have the same probability of occurrence at the trace locations.

Properties of the subterranean formation are measured at one or more wells extending into the subterranean formation using a logging tool (214). The properties can be measured in well logging operation, for example, well logging operation 128. The measured properties can be stored in a well log for each well (216). The well log data can include sonic or acoustic logs, density logs, porosity logs, etc. Well log data can be collected from multiple wells in the target formation. In some implementations, well log data for one or more wells that were previously logged is accessed from a data store.

An acoustic impedance value is calculated at different depths based on the well logs for each well (218). Acoustic impedance can be calculated as a function of density and sound velocity. For example, acoustic impedance can be the product of a measured bulk density of the subsurface formation and a measured compressional sound velocity.

For each well, a residual between the acoustic impedance based on the well log and the initial acoustic impedance volume at the location of the well is calculated (220). The location of each well within the initial acoustic impedance volume can be identified and the values of the initial acoustic impedance at that location can be extracted from the volume. For example, the acoustic impedance based on the well log can be a one dimensional (1D) vector of values representing the acoustic impedance at different depths. A 1D vector of values can be extracted from the initial acoustic impedance volume at the location corresponding to the well representing the initial acoustic impedance at different depths based on the seismic data. The residual can be determined, for example, by taking the difference between the acoustic impedance based on the well log and the initial acoustic impedance volume at the location of the well.

In some implementations, the residual can be segmented based on changes of slope in the initial acoustic impedance volume at the location of the well. Using multiple segments allows a linear regression analysis to represent the variability of the subterranean formation. For each segment, the linear regression is used to fit a line to the residual data. The linear regression determines a slope and an intercept for each segment. A second residual can be determined between the linear regression fits and the residual. The second residual can represent a goodness of the linear regression fit of the residual. The second residual can be correlated with the acoustic impedance data. Little to no correlation between the second residual and the acoustic impedance data can indicate that the majority of discrepancies between the well log and the seismic data have been captured by first residual. This can also be indicated by a second residual without an overall trend in the data. If the second residual includes an overall trend, the segmentation and linear regression steps can be repeated to reduce trends and biases in the data. In repeated iterations, for example, the number of segments can be increased or decreased to better capture the residual between the well log data and the seismically derived data. The second residual can be used as a quality control measure to determine to what extent the discrepancies between the well log acoustic impedance data and the initial acoustic impedance volume are captured by the residual. Descriptive statistics (e.g., mean, standard deviation) can also be used monitor the statistical consistency of the results.

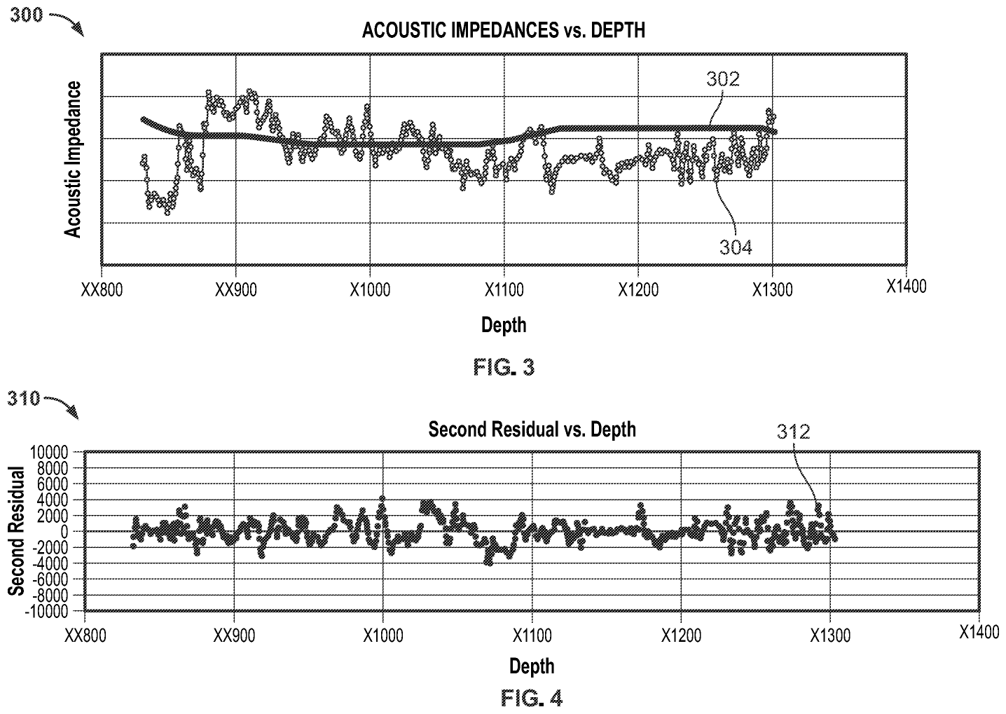

FIG. 3 shows a plot 300 of example acoustic impedance based on seismic data 302 and example acoustic impedance data based on well log data 304 for an example well. Both data series 302, 304 are plotted against depth in the well. The seismically derived data 302 is an extract from a larger 3D volume of acoustic impedance based on seismic data. The data 302 was extracted from the 3D volume at the location corresponding to the well. The acoustic impedance based on well log data 304 is derived from sonic logs and density logs. The well log data 304 has a finer resolution in depth than the seismically derived data 302.

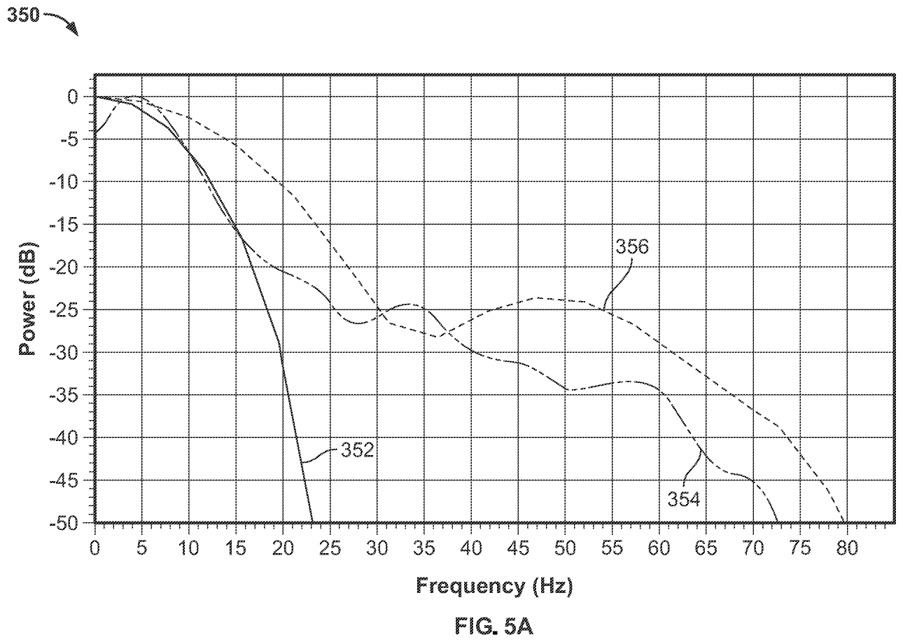

FIG. 4 shows a plot 310 of an example second residual 312 versus well depth calculated as the residual of linear regression fits of the calculated residuals between the acoustic impedance based on seismic data 302 and acoustic impedance based on well log data 304. The lack of an overall trend to the second residual 312 indicates that the linear regression fits of the calculated residuals captured the relevant information.

Turning back to FIG. 2 and method 200, a residual volume is generated based on the calculated residual from the one or more wells (222). The residual volume can be generated to have the same dimensions and resolution as the initial acoustic impedance volume based on the seismic data. The values within the residual volume at the location of the wells can be populated with the calculated residuals for each well from step 220. In some implementations, a spatial interpolation algorithm can be used to calculate residual values between wells. In some implementations, a kriging method is used to calculate residual values between wells. For example, a kriging method can include calculating a spatial covariance structure of the sampled points within the volume (e.g., well locations) and deriving weights based on the spatial covariance structure to interpolate values at unsampled locations (e.g., locations between wells) within the residual volume. In some implementations, the spatial interpolation is based at least in part on the intercepts and slopes determined by the linear regression fits for segments of the calculated residuals for each well. In some implementations, stochastic processes

In some implementations, knowledge of the geological concept or structure of the subterranean formation can be used in the interpolation of the residual volume. For example, the locations of known facies or faults within the subterranean location can be used to determine locations of changes in the acoustic impedance volume. In some implementations, the geological concept (e.g., facies) can be integrated as a condition observed at the well's location. For example, facies codes can be used to run supervised classification processes on well log data to inform segmentation of acoustic impedance data.

A corrected acoustic impedance volume can be generated based on the residual volume and the initial acoustic impedance volume (224). In some implementations, the residual volume is added to the initial acoustic impedance volume to generate the corrected acoustic impedance volume. The corrected acoustic impedance volume can have reduced biases resulting from the seismic data as compared with the initial acoustic impedance volume.

The quality of the improvement in the corrected acoustic impedance volume over the initial acoustic impedance volume can be quantified by a simple CHI squared assessment. The CHI squared assessment compares the variance of the second residual and the variance of the first residual. In an example implementation, the CHI squared value ranged from well to well between 18 and 23 percent. This proportion means, for example, that on average, 80 percent of the discrepancy observed between the initial acoustic impedance volume and the well log based acoustic impedance was captured by the first residual. The remaining 20 percent is assigned to the second residual. In some implementations, stochastic modeling approaches can be used to further improve the quality of the corrected acoustic impedance volume based on the second residual.

In some implementations, steps 220-224 can be performed iteratively. In these implementations, the corrected acoustic impedance volume can become the initial acoustic impedance volume of the subsequent iteration.

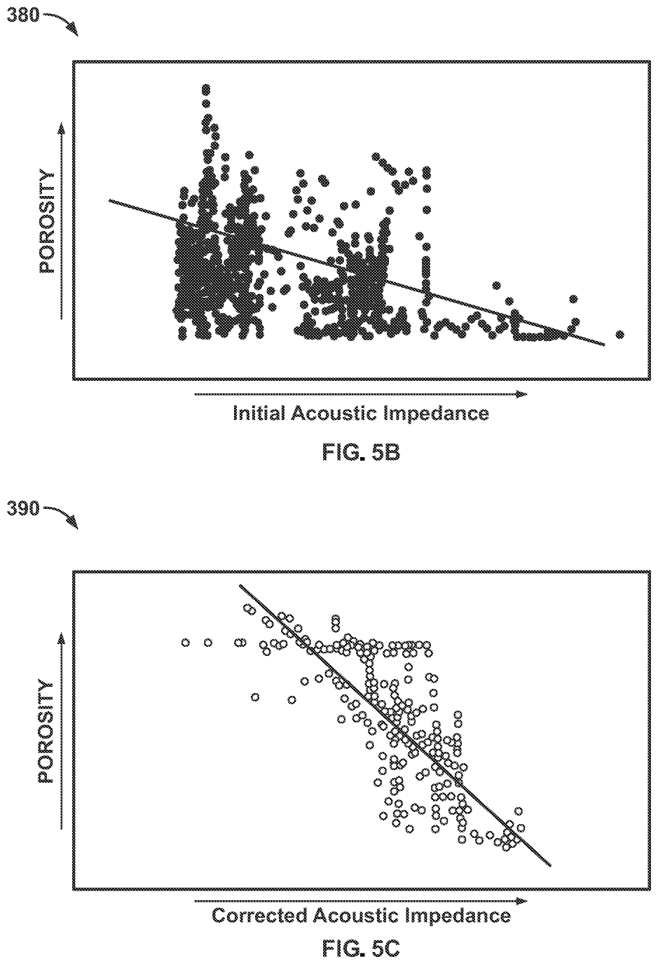

FIG. 5A shows a plot 350 of example acoustic impedance frequency spectra from seismically derived data 352, well log data 354, and a corrected acoustic impedance volume 356. The seismically derived data 352 lacks information for frequencies greater than 25 Hz. The well log data 354 includes high-frequency data to about 75 Hz. An implementation of method 200 can be applied to the seismically derived data 352 and the well log data 354 to generate the data from the corrected acoustic impedance volume 356. The corrected acoustic impedance volume 356 incorporates the high-frequency data from the well log data 354.

In some implementations, datasets of different scales (e.g., seismic volumes with a scale of hundreds of feet and well logs with scales of a few inches) can be integrated to improve a model of the subterranean formation. A relationship can be established between datasets having different scales to prevent spurious correlations between variables and to reduce biases toward variables with higher data density. In some examples, the relationship between an acoustic impedance dataset and a reservoir property (e.g., porosity) can be established by calculating a cross-correlation or a cross-covariance between the datasets.

The corrected acoustic impedance volume includes similar frequency content to well log data (e.g., both the corrected acoustic impedance and well log data show proportional power spectrum characteristics in the frequency domain). Both data sets then satisfy the assumption of proportionality between the variograms of the datasets, and the corrected acoustic impedance volume can be used to determine (at least in part) the distribution of another scarcer parameter (e.g., porosity).

For example, cross-covariance between the corrected acoustic impedance volume and a reservoir property like porosity in the physical space can be denotated as r (Iⱼ, ϕₖ), described in the following equation:

$$r ( {I}_{j} , {ϕ}_{k} ) = cov ( {I}_{j} , {ϕ}_{k} ) \sqrt{var ( {ϕ}_{k} )} \sqrt{var ( {I}_{j} )} ,$$

where I is the acoustic impedance, ϕ is the porosity, and j and k represent indices within the datasets. Cross-covariance is a way to represent the covariance of a variable between two different variables at two separate locations. Cross-covariance is a way to integrate diverse sources of information.

In an example implementation, use of a corrected acoustic impedance volume to determine the distribution of porosity in the subterranean formation improved the correlation of the acoustic impedance as compared with using the initial (e.g., uncorrected) acoustic impedance volume.

FIGS. 5B-5C illustrate correlations between acoustic impedance and reservoir porosity. FIG. 5B shows a plot 380 of the correlation between the initial acoustic impedance volume derived from seismic data and porosity determined based on the initial acoustic impedance volume and porosity well logs. FIG. 5C shows a plot 390 of the correlation between the corrected acoustic impedance volume obtained by application of method 200 and the reservoir porosity determined based on the initial acoustic impedance volume and porosity well logs. The correlation factor improved from 32% in FIG. 5B to 58% in FIG. 5C. The improved porosity model resulted in a sharper image and geologically consistent distribution of sand bodies within the subterranean formation.

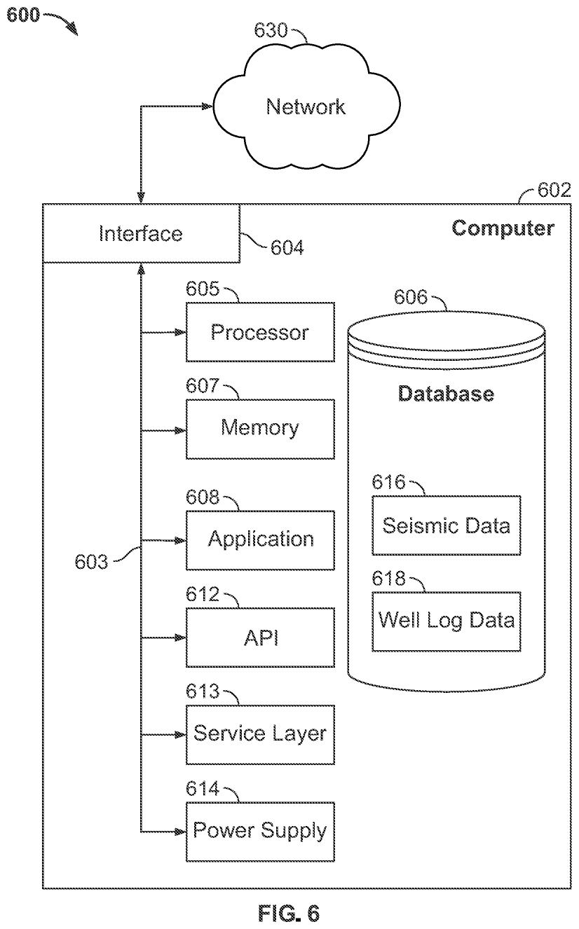

The corrected acoustic impedance volume can be used to determine locations within the subterranean formation where hydrocarbons can be produced. In some implementations, a well can be drilled to access the hydrocarbons at the determined locations. In some implementations, hydrocarbons are produced from the determined locations. In some implementations, a data processing system, such as the computer system described below in reference to FIG. 6, can be used to generate control signals to control drilling devices to drill the wells in the subterranean formation.

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user-or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

What is claimed is:

1. A method for geophysical exploration of a subterranean formation, the method comprising:
acquiring seismic data representing the subterranean formation;
generating an initial acoustic impedance volume based on the seismic data;
measuring properties of the subterranean formation at one or more wells extending into the subterranean formation using a logging tool;
storing values of the measured properties in a well log for each well;
for each well, calculating an acoustic impedance at different depths based on the well log;
for each well, calculating a residual between the acoustic impedance based on the well log and the initial acoustic impedance volume at the location of the well;
generating a residual volume based on the calculated residuals from the one or more wells; and
generating a corrected acoustic impedance volume representing the subterranean formation based on the residual volume and the initial acoustic impedance volume.

2. The method of claim 1, wherein generating a corrected acoustic impedance volume comprises adding the residual volume to the initial acoustic impedance volume.

3. The method of claim 1, wherein the well log comprises at least one of a sonic log and a density log.

4. The method of claim 1, wherein generating a residual volume comprises applying a spatial interpolation between calculated residuals of the one or more wells in the subterranean formation.

5. The method of claim 4, wherein the spatial interpolation comprises a kriging method.

6. The method of claim 5, further comprising:
for each well, segmenting the calculated residual based on slopes of the initial acoustic impedance volume at the location of the well;
for each segment of the calculated residual, determining a slope and an intercept by applying a linear regression fit to the calculated residual; and
wherein the kriging method determines the spatial interpolation between calculated residuals of the one or more wells based at least in part on the determined slopes and intercepts of the segments.

7. The method of claim 1, further comprising iteratively performing steps comprising:
for each well, calculating a residual between the acoustic impedance based on the well log and the corrected acoustic impedance volume at the location of the well;
generating a new residual volume based on the calculated residuals from the one or more wells; and
generating a new corrected acoustic impedance volume representing the subterranean formation based on the residual volume and the corrected acoustic impedance volume,
wherein the corrected acoustic impedance volume comprises the new corrected acoustic impedance volume from the previous iteration.

8. The method of claim 1, further comprising determining a location to produce hydrocarbons from the subterranean formation based at least in part on the corrected acoustic impedance volume.

9. The method of claim 8, further comprising producing hydrocarbons from the subterranean formation.

10. A system for geophysical exploration of a subterranean formation, the system comprising:
at least one processor; and
a memory storing instructions that, when executed by the at least one processor, cause the at least one processor to perform operations comprising:
acquiring seismic data representing the subterranean formation;
generating an initial acoustic impedance volume based on the seismic data;
measuring properties of the subterranean formation at one or more wells extending into the subterranean formation using a logging tool;
storing values of the measured properties in a well log for each well;
for each well, calculating an acoustic impedance at different depths based on the well log;
for each well, calculating a residual between the acoustic impedance based on the well log and the initial acoustic impedance volume at the location of the well;
generating a residual volume based on the calculated residuals from the one or more wells; and
generating a corrected acoustic impedance volume representing the subterranean formation based on the residual volume and the initial acoustic impedance volume.

12. The system of claim 11, wherein generating a residual volume comprises applying a spatial interpolation between calculated residuals of the one or more wells in the subterranean formation.

13. The system of claim 12, wherein the spatial interpolation comprises a kriging method.

14. The system of claim 13, further comprising:
for each well, segmenting the calculated residual based on slopes of the initial acoustic impedance volume at the location of the well;
for each segment of the calculated residual, determining a slope and an intercept by applying a linear regression fit to the calculated residual; and
wherein the kriging method determines the spatial interpolation between calculated residuals of the one or more wells based at least in part on the determined slopes and intercepts of the segments.

15. The system of claim 11, further comprising iteratively performing steps comprising:
for each well, calculating a residual between the acoustic impedance based on the well log and the corrected acoustic impedance volume at the location of the well;
generating a new residual volume based on the calculated residuals from the one or more wells; and
generating a new corrected acoustic impedance volume representing the subterranean formation based on the residual volume and the corrected acoustic impedance volume,
wherein the corrected acoustic impedance volume comprises the new corrected acoustic impedance volume from the previous iteration.

16. One or more non-transitory machine-readable storage devices storing instructions for geophysical modeling of a subterranean formation, the instructions being executable by one or more processing devices to cause performance of operations comprising:
acquiring seismic data representing the subterranean formation;
generating an initial acoustic impedance volume based on the seismic data;
measuring properties of the subterranean formation at one or more wells extending into the subterranean formation using a logging tool;
storing values of the measured properties in a well log for each well;
for each well, calculating an acoustic impedance at different depths based on the well log;
for each well, calculating a residual between the acoustic impedance based on the well log and the initial acoustic impedance volume at the location of the well;
generating a residual volume based on the calculated residuals from the one or more wells; and
generating a corrected acoustic impedance volume representing the subterranean formation based on the residual volume and the initial acoustic impedance volume.

17. The non-transitory machine readable storage devices of claim 16, wherein generating a residual volume comprises applying a spatial interpolation between calculated residuals of the one or more wells in the subterranean formation.

18. The non-transitory machine readable storage devices of claim 17, wherein the spatial interpolation comprises a kriging method.

19. The non-transitory machine readable storage devices of claim 18, further comprising:
for each well, segmenting the calculated residual based on slopes of the initial acoustic impedance volume at the location of the well;
for each segment of the calculated residual, determining a slope and an intercept by applying a linear regression fit to the calculated residual; and
wherein the kriging method determines the spatial interpolation between calculated residuals of the one or more wells based at least in part on the determined slopes and intercepts of the segments.

20. The non-transitory machine readable storage devices of claim 16, further comprising iteratively performing steps comprising:
for each well, calculating a residual between the acoustic impedance based on the well log and the corrected acoustic impedance volume at the location of the well;
generating a new residual volume based on the calculated residuals from the one or more wells; and
generating a new corrected acoustic impedance volume representing the subterranean formation based on the residual volume and the corrected acoustic impedance volume,
wherein the corrected acoustic impedance volume comprises the new corrected acoustic impedance volume from the previous iteration.
